(19) United States
(12) Patent Application Publication
(10) Pub. No.: US 2009/0194663 A1
(43) Pub. Date: Aug. 6, 2009

(54) Gantry Linear Detecting Device

(76) Inventor: Cheng Feng LIN, Taichung (TW)

Correspondence Address: Dr. BANGER SHIA, 102 Lindencrest Ct., Sugar Land, TX, 77479-5201, US

(21) Appl. No.: 12/025,743

(22) Filed: Feb. 4, 2008

(51) Int. Cl. F16M 9/00

(52) U.S. Cl. 248/647

(57) ABSTRACT

A gantry linear detecting device comprises a base, a gantry and a detecting system. The gantry is located on the base. The detecting system includes a first detector and a second detector. The first detector is slidably disposed on the gantry by a linear motor and a linear guideway. The second detector is slidably disposed on the base by an active linear module and a passive linear module. The linear motor and the active linear module move synchronously, thus improving the detecting precision.

### BACKGROUND OF THE INVENTION

1. Field of the Invention

The present invention relates to a detecting device, and more particularly to a gantry linear detecting device.

2. Description of the Prior Art

A conventional linear detecting device comprises a base, a gantry and a detecting system. The gantry is located on the base. The detecting system includes a first detector and a second detector. The first detector is slidably disposed on the gantry by a linear motor and a linear guideway. The second detector is slidably disposed on the base by a linear module and is opposite the first detector.

The first application of the linear module is that: a motor used together with a screw shaft drives a slide block, and the second detector is installed on the slide block to slide with the slide block.

The second application of the linear module is that: a motor used together with a belt drives a slide block, and the second detector is installed on the slide block to slide with the slide block.

Further analysis shows that the above conventional structure has the following disadvantages:

1. The screw shaft and the belt frictionally drive the slide block in a direct contact manner, so the conventional structure cannot achieve a high-speed operation when the travel is long, and further the increase of the travel causes the redesign and purchase of new screw shaft, belt and motor, thus increasing the cost.

2. When the screw shaft and the belt drive the slide block, the direct contact is likely to cause friction loss, and cause vibration after a long time, thus affecting detection quality.

The present invention has arisen to mitigate and/or obviate the afore-described disadvantages.

### SUMMARY OF THE INVENTION

The primary objective of the present invention is to provide a gantry linear detecting device, which can improve detecting precision by utilizing magnetic force to drive a detecting system to move linearly.

In order to achieve the above objective, the gantry linear detection device in accordance with the present invention is used together with an object to be detected and comprises a base, a gantry, and a detecting system. The gantry is located on the base. The detecting system includes a first detector and a second detector, a linear motor and an active linear module. The first detector is disposed on the linear motor and is slidably disposed on the gantry by the linear motor. The second detector is disposed on the active linear module and is slidably disposed on the base by the active linear module. The active linear module and the linear motor move synchronously. The object to be detected is located between the first detector and the second detector, and the first detector and the second detector are located opposite the object to be detected to perform the detecting operation.

The first detector includes a fixing seat and a plurality of sensing heads. The sensing heads are disposed on the fixing seat and are opposite the second detector.

The gantry linear detecting device further comprises a linear guideway. The guideway is parallel to and disposed at one side of the linear motor, and the fixing seat of the first detector is disposed on the linear motor and the linear guideway.

The second detector includes a fixing seat and a plurality of sensing heads. The sensing heads are disposed on the fixing seat and are opposite the first detector.

The gantry linear detecting device further comprises a passive linear module. The active linear module includes a stator and a mover. The mover includes a magnetic hole. The stator is inserted through the magnetic hole of the mover, so as to enable the mover to slide along the stator. The passive linear module is a linear guideway. The passive linear module is parallel to and disposed at one side of the stator of the active linear module. The fixing seat of the second detector is disposed on the active linear module and the passive linear module.

Further analysis shows the present invention has the following advantages:

1. The linear motor and the active linear module are both indirectly contacted, so the present invention can provide a high-speed operation when the travel is long, thus reducing cost.

2. The indirect contact of the linear motor and the active linear module can reduce friction loss, and further avoid occurrence of vibration, thus improving detection quality.

### BRIEF DESCRIPTION OF THE DRAWINGS

FIG. 1 is a plan view of a gantry linear detecting device in accordance with the present invention;

FIG. 2 is a partial view of the gantry linear detecting device of FIG. 1 in accordance with the present invention; and

FIG. 3 is a partial view of the gantry linear detecting device of FIG. 2 in accordance with the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

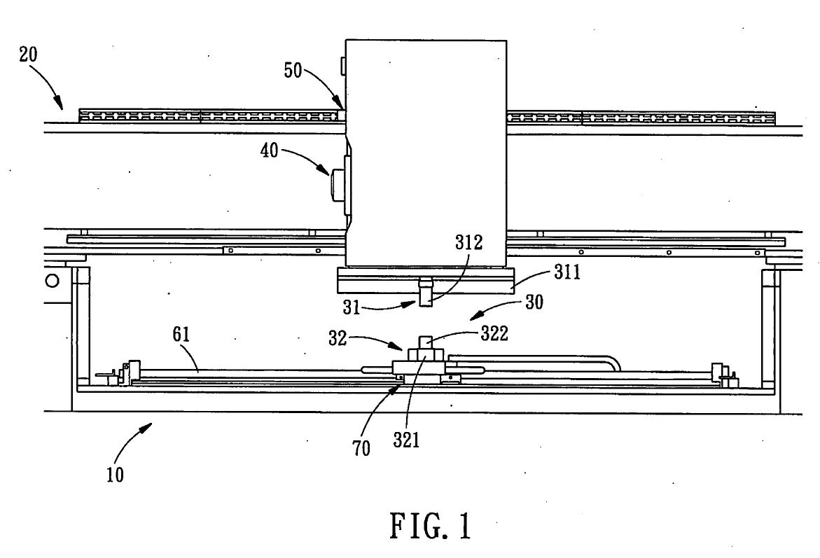

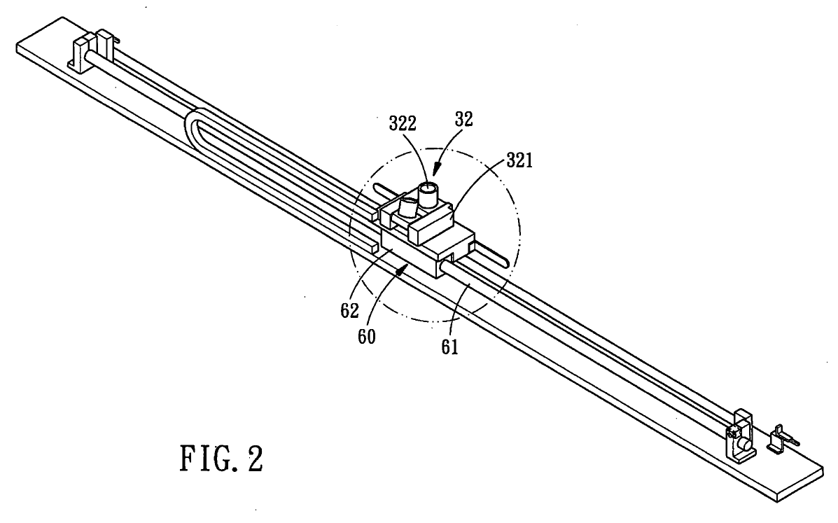

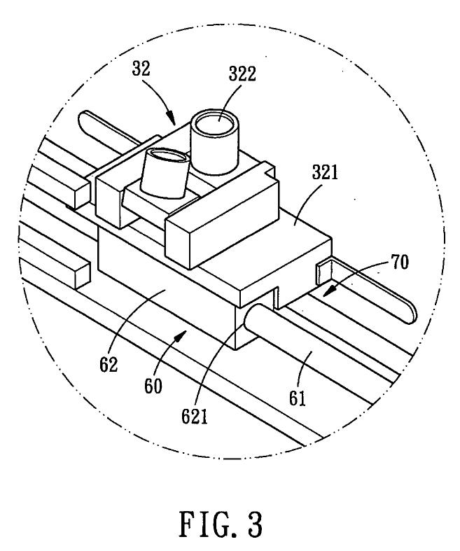

Referring to FIGS. 1-3, a gantry linear detecting device in accordance with the present invention comprises a base 10, a gantry 20, a detecting system 30 and an object to be detected.

The gantry 20 is located on the base 10.

The detecting system 30 includes a first detector 31 and a second detector 32.

The first detector 31 is slidably disposed on the gantry 20 by a linear motor 40 and a linear guideway 50. The first detector 31 includes a fixing seat 311 and a plurality of sensing heads 312. The sensing heads 312 are disposed on the fixing seat 311 and are opposite the second detector 32. The linear motor 40 is parallel to and disposed at one side of linear guideway 50. The fixing seat 311 is disposed on the linear motor 40 and the linear guideway 50.

The second detector 32 is slidably disposed on the base 10 by an active linear module 60 and a passive linear module 70. The second detector 32 includes a fixing seat 321 and a plurality of sensing heads 322. The sensing heads 322 are disposed on the fixing seat 321 and are opposite the first detector 31. The active linear module 60 includes a stator 61 and a mover 62. The stator 61 is in the shape of a cylinder. The mover 62 includes a magnetic hole 621. The stator 61 is inserted through the magnetic hole 621 of the mover 62, so as to enable the move 62 to slide along the stator 61. The passive linear module 70 is a linear guideway. The passive linear module 70 is parallel to and disposed at one side of the stator 61 of the active linear module 60.

The linear motor 40 and the active linear module 60 move synchronously in such a manner that the first detector 31 and the second detector 32 move synchronously too. The object to be detected is placed between the first detector 31 and the second detector 32, and the sensing heads 312 of the first detector 31 and the sensing heads 322 of the second detector 32 are disposed opposite the object to be detected to perform the detection. By such arrangements, the preset invention can provide a long-travel high-speed operation, reduce cost, and reduce the friction loss due to indirect contact, and can avoid occurrence of vibration, etc.

To summarize, the present invention relates to a gantry linear detecting device, which comprises a base, a gantry and a detecting system. The gantry is located on the base. The detecting system includes a first detector and a second detector. The first detector is slidably disposed on the gantry by a linear motor and a linear guideway. The second detector is slidably disposed on the base by an active linear module and a passive linear module. The linear motor and the active linear module move synchronously.

While we have shown and described various embodiments in accordance with the present invention, it is clear to those skilled in the art that further embodiments may be made without departing from the scope of the present invention.

What is claimed is:

1. A gantry linear detecting device being used together with an object to be detected and comprising:
a base;
a gantry located on the base; and
a detecting system including a first detector, a second detector, a linear motor and an active linear module, the first detector being disposed on the linear motor and being slidably disposed on the gantry by the linear motor, the second detector being disposed on the active linear module and being slidably disposed on the base by the active linear module, the active linear module and the linear motor moving synchronously, the object to be detected be disposed between the first detector and the second detector, and the first detector and the second detector being located opposite the object to be detected to perform a detecting operation.

2. The gantry linear detecting device as claimed in claim 1, wherein the first detector includes a fixing seat and a plurality of sensing heads, the sensing heads are disposed on the fixing seat and are opposite the second detector.

3. The gantry linear detecting device as claimed in claim 2 further comprising a linear guideway, wherein the linear guideway is parallel to and disposed at one side of the linear motor, the fixing seat of the first detector is disposed on the linear motor and the linear guideway.

4. The gantry linear detecting device as claimed in claim 1, wherein the second detector includes a fixing seat and a plurality of sensing heads, the sensing heads of the second detector are disposed on the fixing seat and are opposite the first detector.

5. The gantry linear detecting device as claimed in claim 4 further comprising a passive linear module, wherein the active linear module includes a stator and a mover, the mover includes a magnetic hole, the stator is inserted through the magnetic hole of the mover, so as to enable the mover to slide along the stator, the passive linear module is a linear guideway, the passive linear module is parallel to and disposed at one side of the stator of the active linear module, the fixing seat of the second detector is disposed on the active linear module and the passive linear module.
